(19) United States
(12) Patent Application Publication
(10) Pub. No.: US 2024/0375485 A1
(43) Pub. Date: Nov. 14, 2024

(54) Vehicle air conditioning apparatus

(71) Applicant: SANDEN CORPORATION, Gunma (JP)

(72) Inventors: Takayuki MATSUMURA, Gunma (JP); Kenzo OBA, Gunma (JP); Nobutaka SHIMIZU, Gunma (JP)

(21) Appl. No.: 18/575,578

(22) PCT Filed: Jul. 19, 2022
(86) PCT No.: PCT/JP2022/028090

§ 371 Date: Dec. 29, 2023

(30) Foreign Application Priority Data
Jul. 21, 2021 (JP) 2021-121011

(51) Int. Cl. B60H 1/32; B60H 1/00

(52) U.S. Cl. CPC B60H 1/3213; B60H 1/00849; B60H 2001/3272

(57) ABSTRACT

A vehicle air conditioning apparatus includes: a refrigerant circuit including a compressor; a vehicle compartment air conditioning unit including a heat exchanger configured to perform a heat exchange between the-refrigerant and air to be supplied to a vehicle compartment, and an indoor and outdoor air switching device configured to switch a percentage of indoor air or outdoor air introduced into an air flow path of the air subjected to the heat exchange in the heat exchanger; and a controller configured to control the refrigerant circuit and the indoor and outdoor air switching device. The controller is configured to be able to selectively perform operation modes having identical air conditioning purposes and having different refrigerant flow paths of the refrigerant circuit, reduces the number of rotations of the compressor, and switches the indoor and outdoor air switching device to the indoor air circulation, when switching an operation mode.

### TECHNICAL FIELD

The present invention relates to a heat pump vehicle air conditioning apparatus applicable to a vehicle, and specifically to a vehicle air conditioning apparatus having a plurality of operation modes for one air conditioning purpose.

### BACKGROUND ART

Conventionally, there has been known a heat pump vehicle air conditioning apparatus including refrigerant circuit in which a compressor, an indoor heat exchanger, an outdoor heat exchanger, and an expansion valve are connected, and configured to perform air conditioning of the vehicle compartment by supplying the vehicle compartment with the air having been subjected to a heat exchange with the refrigerant in the indoor heat exchanger.

As an example of the vehicle air conditioning apparatus, heat exchangers for temperature-adjustment subject parts are provided in the refrigerant circuit to collect the heat discharged from temperature-adjustment subjects and use the collected heat for heating operation. For example, the vehicle air conditioning apparatus disclosed in Patent Literature 1 has a plurality of operation modes for the heating operation including an outdoor air heat absorption mode in which the heat is absorbed into the refrigerant in an outdoor heat exchanger and a waste heat recovery mode in which the heat is absorbed into the refrigerant in a refrigerant-heat medium heat exchanger, and these modes are selectively switched and performed. The operation mode can be switched by controlling the degree of opening of an electronic expansion valve provided on the refrigerant inlet side of the outdoor heat exchanger and the degree of opening of an electronic expansion valve provided on the refrigerant inlet side of the refrigerant-heat medium heat exchanger to switch the refrigerant flow path, divide the refrigerant flow, and adjust the amount of dividing the refrigerant flow.

Incidentally, when the operation mode is switched, an abnormal noise may occur due to the control of the electronic expansion valve. For example, when the outdoor air heat absorption mode is switched to the waste heat recovery mode, the electronic expansion valve in front of the refrigerant-heat medium heat exchanger is opened. Here, the refrigerant has not flowed into the refrigerant-heat medium heat exchanger until now, and therefore the difference in pressure of the refrigerant is large between the front and the back of the electronic expansion valve. Therefore, when the refrigerant starts rapidly flowing into the refrigerant-heat medium heat exchanger, a relatively large abnormal noise (undesired sound) occurs. To address this, by reducing the number of rotations of a compressor when the operation mode is switched, the difference in pressure between the front and the back of the electronic expansion valve is decreased to prevent the undesired sound in Patent Literature 1.

### CITATION LIST

### Patent Literature

PTL1: Japanese Patent Application Laid-Open No. 2020-97363

### SUMMARY OF INVENTION

### Problem to be solved by the invention

However, in the case where the number of rotations of the compressor is reduced when the operation mode is switched as described above, the system balance of the whole vehicle air conditioning apparatus varies, and therefore the heat exchange performance in the indoor heat exchanger disposed in the flow passage of the air supplied to the vehicle compartment fluctuates. Therefore, the blowing temperature of the air supplied to the vehicle compartment is changed, and consequently passengers may feel uncomfortable.

The present invention has been achieved in consideration of this circumstance, and it is therefore an object of the invention to prevent a fluctuation in the blowing temperature of the air supplied to the vehicle compartment to stabilize the blowing temperature when the operation mode is switched.

### Solution to Problem

An aspect of the invention provides a vehicle air conditioning apparatus including: a refrigerant circuit including a compressor to compress refrigerant, and configured to condense, decompress, and evaporate the compressed refrigerant; a vehicle compartment air conditioning unit including a heat exchanger configured to perform a heat exchange between the refrigerant and air to be supplied to a vehicle compartment, and an indoor and outdoor air switching device configured to switch a percentage of indoor air or outdoor air introduced into an air flow path of the air subjected to the heat exchange in the heat exchanger; and a controller configured to control the refrigerant circuit and the indoor and outdoor air switching device. The controller is configured to be able to selectively perform a plurality of operation modes having identical air conditioning purposes and having different refrigerant flow paths of the refrigerant circuit from each other, reduces the number of rotations of the compressor, and switches the indoor and outdoor air switching device to the indoor air circulation, when switching an operation mode.

### Effect of the invention

According to the invention, it is possible to prevent a fluctuation in the blowing temperature of the air supplied to the vehicle compartment to stabilize the blowing temperature when the operation mode is switched.

### BRIEF DESCRIPTION OF DRAWINGS

FIG. 1 illustrates a schematic configuration of a refrigerant circuit R of a vehicle air conditioning apparatus according to an embodiment of the invention;

FIG. 2 is a block diagram illustrating a schematic configuration of an air conditioning ECU as a controller of the vehicle air conditioning apparatus according to an embodiment of the invention;

FIG. 3 illustrates the flow of refrigerant in the refrigerant circuit R in an outdoor air heat absorption heating mode of the vehicle air conditioning apparatus according to an embodiment of the invention;

FIG. 4 illustrates the flow of the refrigerant in the refrigerant circuit R, and the flow of heat medium when the temperature of a motor unit is adjusted in a device temperature adjustment circuit in a waste heat recovery heating mode of the vehicle air conditioning apparatus according to an embodiment of the invention;

FIG. 5 is a graph illustrating the control of a compressor and expansion valves including an outdoor expansion valve and a chiller expansion valve by the air conditioning ECU, and the change in the blowing temperature under the control when the outdoor air heat absorption heating mode is switched to the waste heat recovery heating mode of the vehicle air conditioning apparatus according to a reference example; and

FIG. 6 is a graph illustrating the control of the compressor and the expansion valves including the outdoor expansion valve and the chiller expansion valve by the air conditioning ECU, and the change in the blowing temperature under the control when the outdoor air heat absorption heating mode is changed to the waste heat recovery heating mode of the vehicle air conditioning apparatus according to an embodiment of the invention.

### DESCRIPTION OF EMBODIMENTS

Hereinafter, an embodiment of the invention will be described in detail with reference to the drawings. In the description below, the same reference number in different drawings denotes the same component with the same function, and duplicate description for each of the drawings is omitted accordingly.

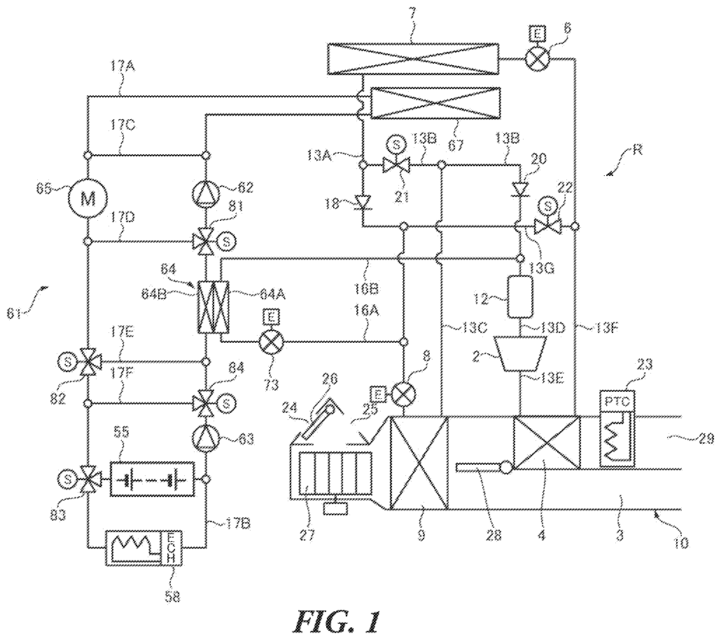

FIG. 1 illustrates a schematic configuration of a vehicle air conditioning apparatus 1 according to an embodiment of the invention. The vehicle air conditioning apparatus 1 is applicable to vehicles, for example, an electric vehicle (EV) without an engine (internal combustion), and a so-called hybrid vehicle using an engine and an electric drive motor together. These vehicles include a battery (e.g. a lithium battery), and is configured to drive and run by supplying the power of the battery charged by an external power source to a motor unit including the drive motor. Also the vehicle air conditioning apparatus 1 is driven by the power supplied from the battery.

The vehicle air conditioning apparatus 1 according to the present embodiment includes a compressor 2 configured to compress refrigerant, and a refrigerant circuit R configured to condense, decompress, and evaporate the compressed refrigerant, and performs heat pump operation with use of the refrigerant circuit R to perform air conditioning (heating, cooling, dehumidifying, and defrosting) of a vehicle compartment. In addition, the vehicle air conditioning apparatus 1 cools and warms up in-vehicle devices such as a battery 55 and a motor unit 65 (temperature-adjustment subject parts) by using a device temperature adjustment circuit 61 as a heat medium circuit provided in the refrigerant circuit R. Here, in the description below, “refrigerant” is medium circulating through the refrigerant circuit R and changing its state in a heat pump (compressed, condensed, expanded, and evaporated), and “heat medium” is medium configured to absorb and release heat without changing its state.

The refrigerant circuit R includes: the compressor 2 configured to compress the refrigerant, an indoor condenser (heat releasing device) 4, as an indoor heat exchanger, provided in an air flow passage 3 of an HVAC unit 10 through which the air of the vehicle compartment is ventilated and circulated, and configured to release the heat from the refrigerant having a high temperature and a high pressure discharged from the compressor 2 and heat the air to be supplied into the vehicle compartment; an outdoor expansion valve 6 configured to decompress and expand the refrigerant during the heating; an outdoor heat exchanger 7 functioning as a heat releasing device (condenser) to release the heat from the refrigerant during the cooling, and configured to cause a heat exchange between the refrigerant and the outdoor air to function as an evaporator to absorb the heat into the refrigerant during the heating; an indoor expansion valve 8 configured to decompress and expand the refrigerant; a heat absorbing device 9 provided in the air flow passage 3 and configured to absorb the heat into the refrigerant from the inside and the outside of the vehicle compartment to cool the air to be supplied into the vehicle compartment during the cooling and the dehumidifying; and an accumulator 12, which are connected by refrigerant pipes 13A to 13G.

The outdoor expansion valve 6 and the indoor expansion valve 8 are electronic expansion valves driven by a pulse motor (not illustrated), and the degree of opening of them is appropriately controlled between the full closing and the full opening based on the number of pulses applied to the pulse motor. The outdoor expansion valve 6 decompresses and expands the refrigerant having flowed from the indoor condenser 4 and flowing into the outdoor heat exchanger 7. The indoor expansion valve 8 decompresses and expands the refrigerant flowing into the heat absorbing device 9, and adjusts the amount of heat being absorbed into the refrigerant in the heat absorbing device 9.

The refrigerant outlet of the outdoor heat exchanger 7 is connected to the refrigerant inlet of the heat absorbing device 9 by the refrigerant pipe 13A. A check valve 18 and the indoor expansion valve 8 are provided in the refrigerant pipe 13A in this order from the outdoor heat exchanger 7 side. The check valve 18 is provided in the refrigerant pipe 13A such that the direction toward the heat absorbing device 9 is the forward direction. The refrigerant pipe 13A branches into the refrigerant pipe 13B at a position on the outdoor heat exchanger 7 side rather than on the check valve 18 side.

The refrigerant pipe 13B branched from the refrigerant pipe 13A is connected to the refrigerant inlet of the accumulator 12. A solenoid valve 21 and a check valve 20 which are opened during the heating operation are provided in the refrigerant pipe 13B in this order from the outdoor heat exchanger 7 side. The check valve 20 is connected such that the direction toward the accumulator 12 is the forward direction. The refrigerant pipe 13B branches into the refrigerant pipe 13C between the solenoid valve 21 and the check valve 20. The refrigerant pipe 13C branched from the refrigerant pipe 13B is connected to the refrigerant outlet of the heat absorbing device 9. The refrigerant outlet of the accumulator 12 is connected to the compressor 2 by the refrigerant pipe 13D.

The refrigerant outlet of the compressor 2 is connected to the refrigerant inlet of the indoor condenser 4 by the refrigerant pipe 13E. One end of the refrigerant pipe 13F is connected to the refrigerant outlet of the indoor condenser 4, and the other end of the refrigerant pipe 13F is connected to the refrigerant inlet of the outdoor heat exchanger 7 via the outdoor expansion valve 6. The refrigerant pipe 13F branches into the refrigerant pipe 13G upstream of the outdoor expansion valve 6 with respect to the refrigerant flow. The refrigerant pipe 13G is connected to the refrigerant pipe A between the check valve 18 and the indoor expansion valve 8. A solenoid valve 22 is provided in the refrigerant pipe 13G upstream from the connection point to the refrigerant pipe A with respect to the refrigerant flow.

By this means, the refrigerant pipe 13G is connected in parallel to a series circuit including the outdoor expansion valve 6, the outdoor heat exchanger 7 and the check valve 18, and forms a bypass circuit configured to bypass the outdoor expansion valve 6, the outdoor heat exchanger 7, and the check valve 18.

As described above, the HVAC unit 10 through which the air of the vehicle compartment is ventilated and circulated includes the air flow passage 3, and the heat absorbing device 9 and the indoor condenser 4 are disposed in the order from the upstream side of the air flow passage 3 with respect to the air flow. An outdoor air intake port 24 and an indoor air intake port 25 are formed upstream of the heat absorbing device 9 with respect to the air flow in the air flow passage 3. An intake switching damper 26 (indoor and outdoor air switching device) is provided for the outdoor air intake port 24 and the indoor air intake port 25. The intake switching damper 26 is configured to adjust the percentage of the indoor air which is the air in the vehicle compartment to be introduced into the air flow passage 3, or the percentage of the outdoor air which is the air outside the vehicle compartment.

That is, the degree of opening of the intake switching damper 26 is controlled by an air conditioning ECU (controller) 11 described later, and therefore it is possible to control such that part or all of the air introduced into the air flow passage 3 is the outdoor air (outdoor air introduction), or such that only the indoor air is introduced into the air flow passage 3 to circulate the indoor air in the vehicle compartment (indoor air circulation), at the percentage depending on the degree of opening of the intake switching damper 26. An indoor blower (blower fan) 27 is provided downstream of the intake switching damper 26 with respect to the air flow, and configured to supply the introduced indoor air or outdoor air to the air flow passage 3.

An auxiliary heater 23 is provided in the air flow passage 3 downstream of the indoor condenser 4 with respect to the air flow. The auxiliary heater 23 illustrated in FIG. 1 is, for example, a PTC heater (electric heater), and is turned on and generates heat to supplement the heating in the vehicle compartment.

An air mix damper 28 is provided upstream of the indoor condenser 4 with respect to the air flow in the air flow passage 3, and configured to adjust the ratio of the air in the air flow passage 3 between the indoor condenser 4 and the auxiliary heater 23 through which the air (the indoor air and the outdoor air) having flowed into the air flow passage 3 and passed through the heat absorbing device 9 is ventilated. The air having flowed through the air flow passage 3 is supplied into the vehicle compartment from a blowing outlet 29 provided downstream of the air mix damper 28 with respect to the air flow in the air flow passage 3. Here, as auxiliary heating means to heat the air to be supplied, for example, a heater core may be disposed in the air flow passage 3 to circulate hot water heated by the heat discharged from the compressor through the heater core.

A refrigerant-heat medium heat exchanger 64 as a heat exchanger for temperature-adjustment subject part is connected to the refrigerant circuit R, and configured to absorb the heat from a temperature-adjustment subject part into the refrigerant. The refrigerant-heat medium heat exchanger 64 includes a refrigerant flow path 64A and a heat medium flow path 64B, and constitutes part of the refrigerant circuit R and also part of the device temperature adjustment circuit 61 as a heat medium circuit.

To be more specific, the refrigerant-heat medium heat exchanger 64 is connected to the refrigerant circuit R as follows. One end of a refrigerant pipe 16A as a branching circuit is connected to the refrigerant circuit R downstream of the check valve 18 provided in the refrigerant pipe 13A and upstream of the indoor expansion valve 8 with respect to the refrigerant flow. The other end of the refrigerant pipe 16A is connected to the inlet of the refrigerant flow path 64A of the refrigerant-heat medium heat exchanger 64. A chiller expansion valve 73 is provided in the refrigerant pipe 16A.

The chiller expansion valve 73 is an electronic expansion valve driven by a pulse motor (not illustrated), and has the degree of opening which is appropriately controlled between the full closing and the full opening based on the number of pulses applied to the pulse motor. The chiller expansion valve 73 decompresses and expands the refrigerant flowing into the refrigerant flow path 64A of the refrigerant-heat medium heat exchanger 64, and adjusts the degree of superheat of the refrigerant on the downstream side of the refrigerant flow path 64A of the refrigerant-heat medium heat exchanger 64.

One end of a refrigerant pipe 16B is connected to the outlet of the refrigerant flow path 64A of the refrigerant-heat medium heat exchanger 64. The other end of the refrigerant pipe 16B is connected to the refrigerant pipe 13B between the check valve 20 and the accumulator 12. In this way, the chiller expansion valve 73, and the refrigerant flow path 64A of the refrigerant-heat medium heat exchanger 64 constitute part of the refrigerant circuit R.

The refrigerant circulating through the refrigerant circuit R is subjected to a heat exchange with the heat medium circulating through the device temperature adjustment circuit 61 by the refrigerant-heat medium heat exchanger 64. The device temperature adjustment circuit 61 adjusts the temperatures of temperature-adjusted subjects such as the battery 55 and the motor unit 65 by circulating the heat medium through the battery 55 and the motor unit 65. Here, the motor unit 65 includes an electric drive motor, and a heat generating device such as an inverter circuit to drive the electric motor. As a temperature-adjusted subject, a heat generating device mounted in the vehicle is applicable, in addition to the battery 55 and the motor unit 65.

The device temperature adjustment circuit 61 includes a first circulating pump 62 and a second circulating pump 63 as circulating devices to circulate the heat medium in the battery 55 and the motor unit 65, an air-heat medium heat exchanger 67, three-way valves 81, 82, 83 and 84 as flow path switching devices, and these components are connected by heat medium pipes 17A to 17F.

In the refrigerant-heat medium heat exchanger 64, one end of the heat medium pipe 17A is connected to one side of the heat medium flow path 64B from which the refrigerant is discharged, and the other end of the heat medium pipe 17A is connected to the heat medium inlet. The three-way valve 81, the first circulating pump 62, the air-heat medium heat exchanger 67, the motor unit 65, the three-way valve 82, the three-way valve 83, the battery 55, the second circulating pump 63, and the three-way valve 84 are provided in the heat medium pipe 17A in this order from one side of the refrigerant-heat medium heat exchanger 64 from which the heat medium is discharged.

In the heat medium pipe 17A, one end of the heat medium pipe 17B is connected to one end of the three-way valve 83, and the other end of the heat medium pipe 17B is connected to the heat medium pipe 17A between the battery 55 and the second circulating pump 63. An ECH (electric coolant heater) 58 is provided in the heat medium pipe 17B.

In addition, the heat medium pipe 17A includes the heat medium pipes 17C to 17F. The heat medium pipe 17C is connected to the heat medium pipe 17A between the first circulating pump 62 and the air-heat medium heat exchanger 67, and between the motor unit 65 and the air-heat medium heat exchanger 67 to bypass the air-heat medium heat exchanger 67. The heat medium pipe 17D is connected to the heat medium pipe 17A between the motor unit 65 and the three-way valve 82, and to one end of the three-way valve 81. The heat medium pipe 17E is connected to one end of the three-way valve 82 and to the heat medium pipe 17A between the three-way valve 84 and the refrigerant-heat medium heat exchanger 64. The heat medium pipe 17F is connected to one end of the three-way valve 84 and to the heat medium pipe 17A between the three-way valve 82 and the three-way valve 83.

In this way, the heat medium flow path 64B of the refrigerant-heat medium heat exchanger 64 constitutes part of the device temperature adjustment circuit 61. With the configuration of the device temperature adjustment circuit 61 as described above, it is possible to control the three-way valves 81, 82, 83, and 84 to flow the heat medium to only the battery 55, only the motor unit 65, or both the battery 55 and the motor unit 65 in the device temperature adjustment circuit 61, and therefore to adjust the temperatures of the battery 55 and the motor unit 65.

As the heat medium used in the device temperature adjustment circuit 61, for example, water, refrigerant such as HFO-1234yf, liquid such as coolant, and gas such as air may be adopted. Here, with the present embodiment, coolant is adopted as the heat medium. In addition, for example, a jacket structure is applied to the periphery of the battery 55 and the motor unit 65, so that heat medium can flow through the jacket structure while a heat exchange with the battery 55 and the motor unit 65 is performed.

When the chiller expansion valve 73 is open, part or the whole of the refrigerant having flowed from the refrigerant pipe 13G and the outdoor heat exchanger 7 flows into the refrigerant pipe 16A, is decompressed by the chiller expansion valve 73, flows into the refrigerant flow path 64A of the refrigerant-heat medium heat exchanger 64, and evaporates. On the other hand, the heat medium having circulated through the device temperature adjustment circuit 61 and absorbed the heat from the battery 55 and the motor unit 65 flows into the heat medium flow path 64B of the refrigerant-heat medium heat exchanger 64. While flowing through the refrigerant flow path 64A of the refrigerant-heat medium heat exchanger 64, the refrigerant absorbs the heat from the heat medium flowing through the heat medium flow path 64B, and then passes through the accumulator 12 and is sucked into the compressor 2.

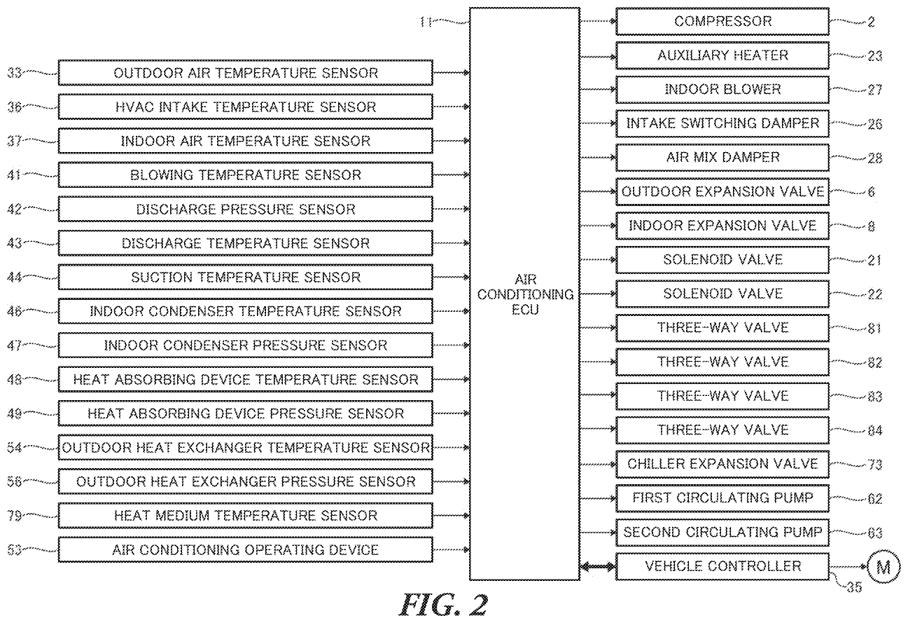

FIG. 2 illustrates a schematic configuration of the air conditioning ECU 11 as a controller of the vehicle air conditioning apparatus 1. The air conditioning ECU 11 is connected to a vehicle controller 35 for the general control of the vehicle including the control of driving, via an in-vehicle network such as a CAN (controller area network) and a LIN (local interconnect network), and therefore can communicate with one another, and send and receive information. A microcomputer as an example of a computer with a processor is applicable to each of the air conditioning ECU 11 and the vehicle controller 35.

Various sensors and detectors are connected to the air conditioning ECU 11 as follows, and outputs of these sensors and detectors are inputted to the air conditioning ECU 11. To be more specific, the air conditioning ECU 11 is connected to an outdoor air temperature sensor 33 configured to detect outdoor air temperature Tam of the vehicle; an HVAC intake temperature sensor 36 configured to detect the temperature of the air introduced from the outdoor air intake port 24 and the indoor air intake port 25 into the air flow passage 3; an indoor air temperature sensor 37 configured to detect temperature Tin of the air in the vehicle compartment; a blowing temperature sensor 41 configured to detect the temperature of the air blowing out from the blowing outlet 29 to the vehicle compartment; a discharge pressure sensor 42 configured to detect the pressure of the refrigerant discharged from the compressor 2 (discharge pressure Pd); a discharge temperature sensor 43 configured to detect discharged refrigerant temperature Td of the compressor 2; a suction temperature sensor 44 configured to detect sucked refrigerant temperature Ts of the compressor 2; an indoor condenser temperature sensor 46 configured to detect temperature TCI of the indoor condenser 4; an indoor condenser pressure sensor 47 configured to detect the pressure of the indoor condenser 4 (the pressure of the refrigerant just after exiting from the indoor condenser 4: indoor condenser exit pressure Pci); a heat absorbing device temperature sensor 48 configured to detect temperature Te of the heat absorbing device 9; a heat absorbing device pressure sensor 49 configured to detect the refrigerant pressure of the heat absorbing device 9; an air conditioning operating device 53 configured to set the preset temperature and the switching of the air conditioning operation; an outdoor heat exchanger temperature sensor 54 configured to detect temperature TXO of the outdoor heat exchanger 7; an outdoor heat exchanger pressure sensor 56 configured to detect refrigerant pressure PXO of the outdoor heat exchanger 7; and a heat medium temperature sensor 79 configured to detect temperature Tw (hereinafter, referred to as “chiller water temperature”) of the heat medium having exited from the heat medium flow path 64B of the refrigerant-heat medium heat exchanger 64 and circulating through the heat medium circuit.

On the other hand, the output of the air conditioning ECU 11 is connected to the compressor 2, the indoor blower (blower fan) 27, the intake switching damper 26, the air mix damper 28, the outdoor expansion valve 6, the indoor expansion valve 8, the solenoid valves 21 and 22, the three-way valves 81, 82, 83, and 84, the chiller expansion valve 73, the first circulating pump 62, and the second circulating pump 63. The air conditioning ECU 11 controls these components based on the output of each of the sensors, the setting inputted by the air conditioning operating device 53, and the information from the vehicle controller 35.

The operating actions of the vehicle air conditioning apparatus 1 having the above-described configuration will be described. The air conditioning ECU (controller) 11 according to the present embodiment has a plurality of operation modes having identical air conditioning purposes and having different refrigerant flow paths of the refrigerant circuit from each other, and can appropriately select and perform the operation mode from among the plurality of operation modes. For example, as operation modes for “heating purpose”, the air conditioning ECU 11 has at least two operation modes including an outdoor air heat absorption heating mode to absorb the heat by the outdoor heat exchanger 7, and a waste heat recovery heating mode to absorb the heat by the refrigerant-heat medium heat exchanger 64, and can appropriately select and perform these operation modes.

Hereinafter, these operation modes for “heating purpose”, and switching of these operation modes will be described. Here, as an operation mode for “heating purpose”, the air conditioning ECU 11 may have a combination heating mode to absorb the heat by both the outdoor heat exchanger 7 and the refrigerant-heat medium heat exchanger 64, in addition to the above-described two modes.

### Operation Modes for Heating Purpose

### (1) Outdoor Air Heat Absorption Heating Mode

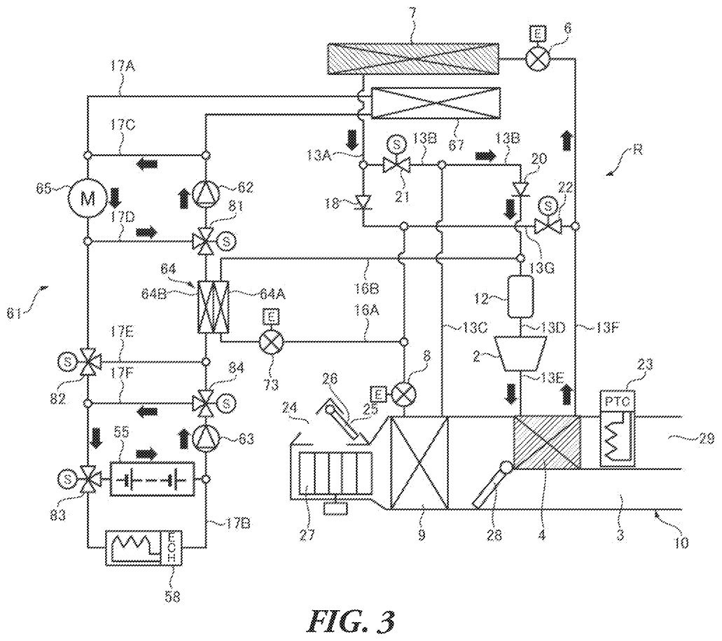

FIG. 3 illustrates the refrigerant flow (arrows) in the refrigerant circuit R in the outdoor air heat absorption heating mode. The heating operation is selected by the air conditioning ECU 11 (automatic mode) or by manually operating the air conditioning operating device 53 (manual mode). When performing the outdoor air heat absorption heating mode, the air conditioning ECU 11 opens the solenoid valve 21, and fully closes the indoor expansion valve 8, the chiller expansion valve 73, and the solenoid valve 22. The degree of opening of the outdoor expansion valve 6 can be controlled. The outdoor air intake port 24 is opened by the intake switching damper 26.

The air conditioning ECU 11 actuates the indoor blower 27 to flow the air including the outdoor air taken from the outdoor air intake port 24 through the air flow passage 3, and causes the air mix damper 28 to ventilate the indoor condenser 4 and the auxiliary heater 23 by the air blowing out from the indoor blower 27. Meanwhile, the compressor 2 is actuated to allow gas refrigerant having a high temperature and a high pressure discharged from the compressor 2 to flow into the indoor condenser 4. The indoor condenser 4 is ventilated by the air in the air flow passage 3, and therefore the air in the air flow passage 3 is heated by the refrigerant having a high temperature in the indoor condenser 4, and the heated air is supplied from the blowing outlet 29 into the vehicle compartment. On the other hand, the heat of the refrigerant in the indoor condenser 4 is removed by the air, and consequently condensed and liquefied.

The refrigerant liquefied in the indoor condenser 4 exits from the indoor condenser 4, and then passes through the refrigerant pipe 13F, and reaches the outdoor expansion valve 6. The refrigerant is decompressed by the outdoor expansion valve 6, flows into the outdoor heat exchanger 7, evaporates in the outdoor heat exchanger 7, and absorbs the heat from the outdoor air flowing from the outside while the vehicle is moving. That is, the refrigerant circuit R functions as a heat pump.

The refrigerant with a low temperature and a low pressure having exited from the outdoor heat exchanger 7 passes through the refrigerant pipe 13A, the refrigerant pipe 13B, the solenoid valve 21, and the check valve 20, and flows into the accumulator 12. The refrigerant is separated into gas and liquid in the accumulator 12, and then gas refrigerant passes through the refrigerant pipe 13D and is sucked into the compressor 2. This circulation of the refrigerant is repeated. This circulation allows the heating of the vehicle compartment.

During the heating operation in the outdoor air heat absorption heating mode, the air conditioning ECU 11 calculates target indoor condenser pressure PCO (the target value of pressure PCI of the indoor condenser 4) from target blowing temperature TAO which is determined based on the preset temperature set by a user with use of the air conditioning operating device 53. The air conditioning ECU 11 controls the number of rotations of the compressor 2, based on the target indoor condenser pressure PCO, and the refrigerant pressure of the indoor condenser 4 (the indoor condenser pressure PCI) detected by the indoor condenser pressure sensor 47.

The air conditioning ECU 11 controls the degree of opening of the outdoor expansion valve 6, based on the temperature of the indoor condenser 4 (indoor condenser temperature TCI) detected by the indoor condenser temperature sensor 46, and the indoor condenser pressure PCI detected by the indoor condenser pressure sensor 47 (normal control of the valve action during the outdoor air heat absorption heating mode). When the heating performance of the indoor condenser 4 is insufficient, the auxiliary heater 23 is turned on to generate heat, so that the heating is supplemented.

Meanwhile, in the device temperature adjustment circuit 61, the heat medium is circulated through the motor unit 65, and the heat medium pipes 17A, 17C, and 17C by the first circulating pump 62. In addition, the heat medium is circulated through the battery 55, and the heat medium pipes 17A and 17F by the second circulating pump 63.

### (2) Waste Heat Recovery Heating Mode

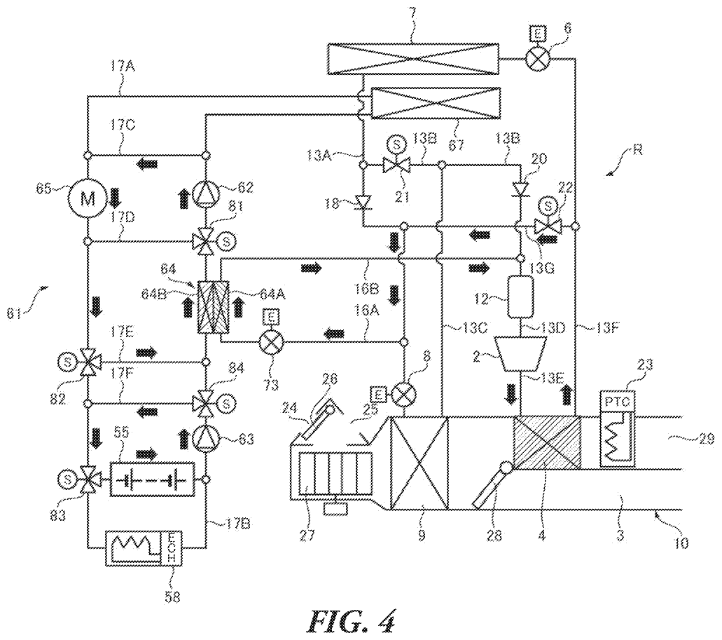

FIG. 4 illustrates the flow of the refrigerant in the refrigerant circuit R and the flow of the heat medium in the device temperature adjustment circuit 61 in the waste heat recovery heating mode. When performing the waste heat recovery heating mode, the air conditioning ECU 11 closes the solenoid valve 21, fully closes the outdoor expansion valve 6 and the indoor expansion valve 8, and opens the solenoid valve 22. In addition, the chiller expansion valve 73 is opened and the degree of opening of the chiller expansion valve 73 can be controlled. The air conditioning ECU 11 causes the intake switching damper 26 to open the outdoor air intake port 24, actuates the indoor blower 27 to flow the air including the outdoor air taken from the outdoor air intake port 24 through the air flow passage 3, and causes the air mix damper 28 to ventilate the indoor condenser 4 and the auxiliary heater 23 by the air blowing out from the indoor blower 27.

The air conditioning ECU 11 actuates the compressor 2 to allow gas refrigerant having a high temperature and a high pressure discharged from the compressor 2 to flow into the indoor condenser 4, and the indoor condenser 4 is ventilated by the air in the air flow passage 3. The air in the air flow passage 3 is heated by the refrigerant having a high temperature in the indoor condenser 4, and the heated air is supplied from the blowing outlet 29 into the vehicle compartment. On the other hand, the heat of the refrigerant in the indoor condenser 4 is removed by the air, and consequently condensed and liquefied.

The whole refrigerant having exited from the indoor condenser 4 flows into the solenoid valve 22, passes through the refrigerant pipes 13G and 13A, and flows into the refrigerant pipe 16A. The refrigerant passes the refrigerant pipe 16A, is decompressed by the chiller expansion valve 73, and then passes through the refrigerant pipe 16A, flows into the refrigerant flow path 64A of the refrigerant-heat medium heat exchanger 64, and evaporates. At this time, the refrigerant exhibits heat absorption effect. The refrigerant having evaporated in the refrigerant flow path 64A passes through the refrigerant pipe 16B, flows into the refrigerant pipe 13B downstream of the check valve 20, passes through the accumulator 12 and the refrigerant pipe 13D, and is sucked into the compressor 2. This circulation of the refrigerant is repeated. This circulation allows the heating of the vehicle compartment.

During the heating operation in the waste heat recovery heating mode, the air conditioning ECU 11 calculates the target indoor condenser pressure PCO (the target value of pressure PCI of the indoor condenser 4) from the target blowing temperature TAO which is determined based on the preset temperature set by a user with use of the air conditioning operating device 53. The air conditioning ECU 11 controls the number of rotations of the compressor 2, based on the target indoor condenser pressure PCO, and the refrigerant pressure of the indoor condenser 4 (the indoor condenser pressure PCI) detected by the indoor condenser pressure sensor 47.

The air conditioning ECU 11 controls the degree of opening of the chiller expansion valve 73, based on the temperature of the indoor condenser 4 (the indoor condenser temperature TCI) detected by the indoor condenser temperature sensor 46, and the indoor condenser pressure PCI detected by the indoor condenser pressure sensor 47 (normal control of the valve action during the waste heat recovery heating mode). When the heating performance of the indoor condenser 4 is insufficient, the auxiliary heater 23 is turned on to generate heat, so that the heating is supplemented.

On the other hand, the heat recovery of the device temperature adjustment circuit 61 includes the following three cases: a case where the temperature of the battery 55 is adjusted to recover the heat from the battery 55; a case where the temperature of the motor unit 65 is adjusted to recover the heat from the motor unit 65; and a case where the temperatures of the battery 55 and the motor unit 65 are adjusted to recover the heat from the battery 55 and the motor unit 65.

FIG. 4 illustrates an example where the temperature of the motor unit 65 is adjusted to recover the heat from the motor unit 65. In the case illustrated in FIG. 4 where the heat is recovered from the motor unit 65, the heat medium is circulated by the first circulating pump 62. The heat medium having exited from the first circulating pump 62 passes through the heat medium pipes 17A and 17C, flows into the motor unit 65, and is subjected to a heat exchange in the motor unit 65. The heat medium having been subjected to the heat exchange in the motor unit 65 passes through the heat medium pipe 17A, the three-way valve 82, and the heat medium pipe 17E, and reaches the heat medium flow path 64B of the refrigerant-heat medium heat exchanger 64. The heat of the heat medium is absorbed into the refrigerant evaporating in the refrigerant flow path 64A of the refrigerant-heat medium heat exchanger 64, and the heat medium is cooled. The heat medium cooled by the heat absorption effect of the refrigerant exits from the refrigerant-heat medium heat exchanger 64, passes through the three-way valve 81, and is delivered to the heat medium pipe 17A by the first circulating pump 62, and flows into the motor unit 65 again. This circulation of the heat medium is repeated.

In this way, in the waste heat recovery heating mode, the refrigerant of the refrigerant circuit R evaporates in the refrigerant-heat medium heat exchanger 64 and absorbs the heat from only the heat medium in the device temperature adjustment circuit 61. In other words, the refrigerant does not flow into the outdoor heat exchanger 7 and evaporate, but draws the heat from the motor unit 65 via the heat medium. Therefore, it is possible to cool the motor unit 65 and carry the heat drawn from the motor unit 65 to the indoor condenser 4, and consequently to heat the vehicle compartment.

### Switching of Operation Modes

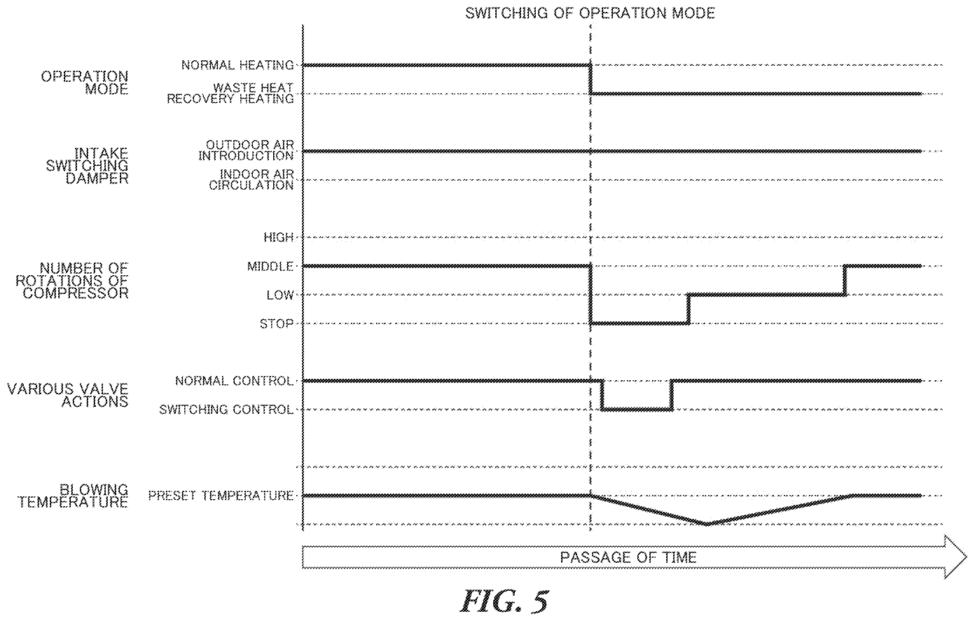

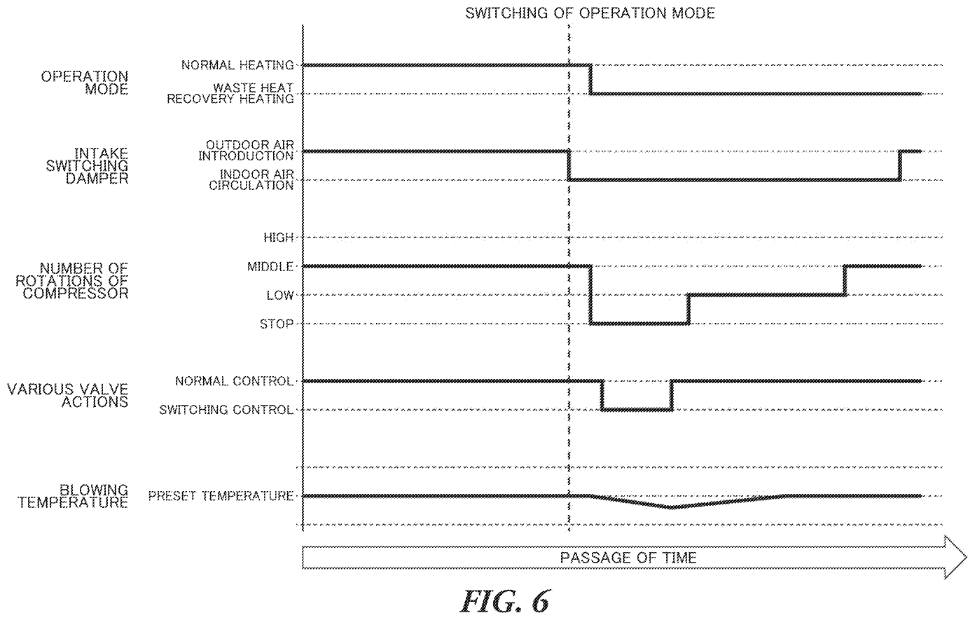

Hereinafter, switching from the outdoor air heat absorption heating mode to the waste heat recovery heating mode will be described with reference to FIG. 5 and FIG. 6. Each of FIG. 5 and FIG. 6 is a graph illustrating the control of the compressor 2, and the expansion valves including the outdoor expansion valve 6 and the chiller expansion valve 73 by the air conditioning ECU 11, and the change in the blowing temperature under the control. FIG. 5 illustrates the control and the result of the control in the vehicle air conditioning apparatus according to a reference example, and FIG. 6 illustrates the control and the result of the control in the vehicle air conditioning apparatus according to the present embodiment.

### (1) Switching of Operation Modes According to Reference Example

As illustrated in FIG. 5, in the vehicle air conditioning apparatus according to the reference example, when starting switching from the outdoor air heat absorption heating mode to the waste heat recovery heating mode, the air conditioning ECU 11 immediately stops the compressor 2, and controls the switching of the expansion valves between opening and closing while the compressor 2 is stopped. That is, the air conditioning ECU 11 controls to close the solenoid valve 21, fully close the outdoor expansion valve 6 and the indoor expansion valve 8, and open the solenoid valve 22. In this case, the air conditioning ECU 11 controls the degree of opening of the chiller expansion valve 73 to become a target valve until the outdoor expansion valve 6 becomes fully closed, while controlling the outdoor expansion valve 6 to be fully closed. The degree of opening of the chiller expansion valve 73 can be controlled based on the temperature of the indoor condenser 4 and so forth.

In addition, the air conditioning ECU 11 switches the three-way valve 81 to control such that the heat medium circulating through the motor unit 65 flows into the refrigerant-heat medium heat exchanger 64 in the device temperature adjustment circuit 61. By this means, the heat medium having drawn the heat discharged from the motor unit 65 is subjected to a heat exchange with the refrigerant having circulated through the refrigerant circuit R in the refrigerant-heat medium heat exchanger 64. After that, the air conditioning ECU 11 actuates the compressor 2 according to a predetermined condition, and controls to increase the number of rotations of the compressor 2 in stages.

When switching the operation mode described above, the air conditioning ECU 11 does not operate the intake switching damper 26 to maintain a state in which the indoor air intake port 25 is closed and the outdoor air intake port 24 is open. In this case, the compressor 2 is temporarily stopped, and restarted after a predetermined period of time has elapsed. Here, the number of rotations of the compressor 2 after the restart is smaller for a predetermined period of time than the number of rotations in the outdoor air heat absorption heating mode. Therefore, the system balance of the whole vehicle air conditioning apparatus 1 is changed.

To be more specific, during the operation in the outdoor air heat absorption heating mode, the refrigerant is sufficiently compressed by the compressor 2. However, during the control of switching the operation mode, the compressor 2 is stopped, or operated with the reduced number of rotations, and therefore the compression performance of the compressor 2 to compress the refrigerant is stopped or deteriorated. Consequently, the temperature of the refrigerant passing through the indoor condenser 4 is reduced, and therefore to deteriorate the heat exchange performance in the indoor condenser 4 in which a heat exchange is performed between the refrigerant and the air. By this means, the air taken from the outdoor air intake port 24 and passing through the air flow passage 3 is not sufficiently heated in the indoor condenser 4, and therefore the blowing temperature of the air supplied from the blowing outlet 29 into the vehicle compartment is decreased. This may cause the passengers to feel uncomfortable.

(2) Switching of Operation Modes According to the present Embodiment

As illustrated in FIG. 6, according to the present example, when starting switching from the outdoor air heat absorption heating mode to the waste heat recovery heating mode, the air conditioning ECU 11 controls to immediately actuate the intake switching damper 26 to close the outdoor air intake port 24 and open the indoor air intake port 25, and therefore to introduce only the indoor air into the air flow passage 3 (indoor air circulation). The air conditioning ECU 11 stops the compressor 2 while only the indoor air is circulated in the air flow passage 3, and controls the switching of the expansion valves between opening and closing while the compressor 2 is stopped.

That is, the air conditioning ECU 11 controls to fully close the solenoid valve 21, the outdoor expansion valve 6, and the indoor expansion valve 8, and open the solenoid valve 22 while making the inner circulation of the air flow passage 3 and stopping the compressor 2. In this case, the air conditioning ECU 11 controls the degree of opening of the chiller expansion valve 73 to become the target valve until the outdoor expansion valve 6 is fully closed. After having the target value, the degree of opening of the chiller expansion valve 73 can be controlled depending on the temperature of indoor condenser 4. After that, the air conditioning ECU 11 actuates the compressor 2 again, and controls to increase the number of rotations of the compressor 2 in stages.

It is possible to preset the period of time for which the compressor 2 is stopped, in other words, the timing at which the compressor 2 is restarted, and the timing at which the number of rotations is increased. In addition, the timing at which the number of rotations of the compressor 2 is increased may be determined, based on, for example, the detection result of the blowing temperature of the air blowing out from the blowing outlet 29, or the indoor condenser temperature TCI.

After the compressor 2 is stopped, or the number of rotations of the compressor 2 is reduced for the predetermined period of time, when a predetermined condition is satisfied, the air conditioning ECU 11 controls the intake switching damper 26 to open the outdoor air intake port 24, and therefore to introduce the outdoor air into the air flow passage 3. As the predetermined condition, it is possible to preset a case where the number of rotations of the compressor 2 is equal to that for the normal heating operation, or a case where the blowing temperature is equal to the preset temperature determined by the user. In addition, the air conditioning ECU 11 may control to synchronize the timing at which the number of rotations of the compressor 2 is increased with the timing at which the intake switching damper 26 is switched to introduce the outdoor air.

Here, the example has been described where the compressor 2 is temporarily stopped (the number of rotations is zero) when the operation mode is switched. However, the number of rotations does not necessarily need to be zero, but may be controlled to be temporarily reduced. It is possible to preset the time at which the number of rotations of the compressor 2 is reduced, or the time at which the compressor 2 is stopped, or for example, the time may be determined based on the blowing temperature.

Moreover, the example has been described where the air supplied into the vehicle compartment is subjected to a heat exchange in the indoor condenser 4 directly with the refrigerant circulating through the refrigerant circuit R. However, this is by no means limiting, but, for example, a heat medium circuit may be provided to perform a heat exchange with the refrigerant of the refrigerant circuit R, so that the refrigerant may be subjected to a heat exchange with the air to be supplied to the vehicle compartment via the heat medium.

As described above, according to the present embodiment, when the outdoor air heat absorption heating mode is switched to the waste heat recovery heating mode, that is, when one operation mode of the air conditioning where at least part of air introduced into the air flow passage is outdoor air is switched to another operation mode having the same air conditioning purpose as that of the one operation mode, the vehicle air conditioning apparatus 1 controls the intake switching damper 26 to make the indoor air circulation of the air flow passage.

By this means, the air having been heated to the preset temperature in the indoor condenser 4 and circulated through the vehicle compartment can be flowed to the indoor condenser 4 again until just before the operation mode is switched. That is, with the indoor circulation, the temperature of the air subjected to a heat exchange with the refrigerant in the indoor condenser 4 can be higher than the outdoor air.

When the number of rotations of the compressor 2 is reduced, or the compressor 2 is stopped, the refrigerant is not sufficiently heated to deteriorate the heat exchange performance in the indoor condenser 4. However, the temperature of the air subjected to a heat exchange with the refrigerant in the indoor condenser 4 is higher than the temperature of the outdoor air as described above. Consequently, it is possible to prevent a decrease in the temperature of the air blowing to the vehicle compartment without need of high performance of the heat exchange in the indoor condenser 4.

As described above, the embodiments of the present invention have been described in detail with reference to the drawings. However, the specific configuration is not limited to these embodiments, and the design can be changed without departing from the scope of the present invention.

### REFERENCE SIGNS LIST

1: vehicle air conditioning apparatus, 2: compressor,
3: air flow passage, 4: indoor condenser,
6: outdoor expansion valve, 7: outdoor heat exchanger,
8: indoor expansion valve, 9: heat absorbing device,
10: HVAC unit, 11: air conditioning ECU (controller),
21: solenoid valve, 22: solenoid valve,
24: outdoor air intake port, 25: indoor air intake port,
26: intake switching damper, 27: indoor blower (blower fan),
55: battery, 61: device temperature adjustment circuit,
62: first circulating pump, 63: second circulating pump,
64: refrigerant-heat medium heat exchanger,
65: motor unit, 73: chiller expansion valve

1. A vehicle air conditioning apparatus comprising:
a refrigerant circuit including a compressor to compress refrigerant, and configured to condense, decompress, and evaporate the compressed refrigerant;
a vehicle compartment air conditioning unit including:
a heat exchanger configured to perform a heat exchange between the refrigerant and air to be supplied to a vehicle compartment; and
an indoor and outdoor air switching device configured to switch a percentage of indoor air or outdoor air introduced into an air flow path of the air subjected to the heat exchange in the heat exchanger; and
a controller configured to control the refrigerant circuit and the indoor and outdoor air switching device,
wherein the controller is configured to be able to selectively perform a plurality of operation modes having identical air conditioning purposes and having different refrigerant flow paths of the refrigerant circuit from each other, and
the controller reduces the number of rotations of the compressor, and switches the indoor and outdoor air switching device to the indoor air circulation, when switching an operation mode.

2. The vehicle air conditioning apparatus according to claim 1, wherein after switching the indoor and outdoor air switching device to the indoor circulation, the controller reduces the number of rotations of the compressor for a predetermined period of time.

3. The vehicle air conditioning apparatus according to claim 2, wherein after reducing the number of rotations of the compressor for the predetermined period of time, the controller switches the indoor and outdoor air switching device to the indoor air circulation, when a predetermined condition is satisfied.

4. The vehicle air conditioning apparatus according to claim 3, wherein the controller increases the number of rotations of the compressor at a timing of switching the indoor and outdoor air switching device to the outdoor air introduction.

5. The vehicle air conditioning apparatus according to claim 3, wherein after reducing the number of rotations of the compressor for the predetermined period of time, the controller increases the number of rotations of the compressor in stages according to a predetermined condition.

6. The vehicle air conditioning apparatus according to claim 1, wherein when a temperature of the air supplied to the vehicle compartment is higher than a predetermined temperature, the controller switches the indoor and outdoor air switching device to the outdoor air introduction.

7. The vehicle air conditioning apparatus according to claim 1, wherein the operation mode is switched from one operation mode of air conditioning where at least part of the air introduced into the air flow passage is the outdoor air to another operation mode having an air conditioning purpose which is the same as that of the one operation mode.

8. The vehicle air conditioning apparatus according to claim 1, wherein:
the air conditioning purpose is heating of the vehicle compartment;
the operation modes includes an outdoor air heat absorption heating mode to absorb heat into the refrigerant of the refrigerant circuit by an outdoor heat exchanger, and a waste heat recovery heating mode to absorb heat into the refrigerant of the refrigerant circuit by a heat exchanger for temperature-adjustment subject part; and
when the outdoor air heat absorption heating mode is switched to the waste heat recovery heating mode, the controller reduces the number of rotations of the compressor, and switches the indoor and outdoor air switching device to the indoor air circulation.
